(19) United States
(12) Patent Application Publication
(10) Pub. No.: US 2016/0364367 A1
(43) Pub. Date: Dec. 15, 2016

(54) INFORMATION PROCESSING DEVICE FOR EDITING ELECTRONIC DATA BY TOUCH OPERATIONS

(71) Applicant: FANUC CORPORATION, Yamanashi (JP)

(72) Inventor: Yuusuke TAKAYAMA, Yamanashi (JP)

(21) Appl. No.: 15/172,642

(22) Filed: Jun. 3, 2016

(30) Foreign Application Priority Data
Jun. 9, 2015 (JP) 2015-116502

(51) Int. Cl. G06F 17/21; B25J 13/08; G06F 17/24; G06F 3/0488; G06F 17/22

(52) U.S. Cl. CPC G06F 17/211; G06F 3/04883; G06F 17/2205; G06F 17/24; B25J 13/081; G06F 2203/04808

(57) ABSTRACT

An information processing device comprises a storage unit for storing electronic data in ASCII format containing a plurality of line data, a display control unit for displaying electronic data stored in the storage unit on a touch screen, and an editing unit for editing electronic data stored in the storage unit so that, in response to a first touch operation performed in an area containing a boundary between two adjacent line data displayed on the touch screen, a new line datum is added between the two adjacent line data.

### BACKGROUND OF THE INVENTION

1. Technical Field

The present invention relates to an information processing device used for displaying and editing electronic data in ASCII format.

2. Description of the Related Art

When electronic data in ASCII format are edited, an operator can edit the data displayed on the screen of a display device while checking the contents of the data. When, for example, a new line datum is added, an operator should perform a specific command input or key operation. When a line datum is added by mistake, an operator should delete the datum. Thus, an operator should acquire methods of operation for editing electronic data.

Touch screens configured to detect touch operations of fingers of a user have been widely used. Information processing devices to be used along with the touch screens execute a predetermined task in response to touch operations on each touch screen, and accordingly, can be intuitively operated. Thus, even a less skilled operator can easily operate a terminal in comparison with a conventional method which requires complicated command inputs or key operations.

Japanese Unexamined Patent Publication (Kokai) No. 2014-142911 discloses an information processing device having an editing means which enables an operator to add a new page or divide a file when performing a pinch-out operation between pages in electronic data.

However, the information processing device disclosed in Patent Document 1 can handle only an editing task in units of pages, and cannot handle, for example, addition of a new line datum in the same page or an editing task for data constituting a single page.

Thus, information processing devices which can easily edit electronic data in ASCII format have been required.

### SUMMARY OF INVENTION

A first aspect of the invention of this application provides an information processing device comprising: a storage unit for storing electronic data in ASCII format containing a plurality of line data: a display control unit for displaying electronic data stored in the storage unit on a touch screen; and an editing unit for editing electronic data stored in the storage unit so that, in response to a first touch operation performed in an area containing a boundary between two adjacent line data displayed on the touch screen, a new line datum is added between the two adjacent line data.

A second aspect of the invention of this application provides the information processing device according to the first aspect of the invention, wherein the editing unit is configured to change the number of new line data to be added, in response to the quantity of the first touch operation.

A third aspect of the invention of this application provides the information processing device according to the first or second aspect of the invention, wherein the information processing device further has a highlight display unit for highlighting the new line datum; and the editing unit is configured to edit electronic data stored in the storage unit so that the highlighted new line datum is deleted in response to a second touch operation performed on the touch screen.

A fourth aspect of the invention of this application provides the information processing device according to the third aspect of the invention, wherein the editing unit is configured to change the number of new line data to be deleted, in response to the quantity of the second touch operation.

A fifth aspect of the invention of this application provides the information processing device according to the third or fourth aspect of the invention, wherein the touch screen is a multi-touch screen which can detect a multi-touch operation; and the second touch operation is a pinch-in operation.

A sixth aspect of the invention of this application provides the information processing device according to the third or fourth aspect of the invention, wherein the second touch operation is a swipe operation.

A seventh aspect of the invention of this application provides the information processing device according to any of the first to sixth aspects of the invention, wherein the touch screen is a multi-touch screen which can detect a multi-touch operation; and the first touch operation is a pinch-out operation.

These and other objects, features and advantages of the present invention will become more apparent in light of the detailed description of exemplary embodiments thereof as illustrated by the drawings.

### BRIEF DESCRIPTION OF DRAWINGS

FIG. 1 is a schematic view of a robot system comprising an information processing device according to an embodiment.

FIG. 2 is a diagram showing the hardware configuration of an information processing device.

FIG. 3 is a functional block diagram of an information processing device.

FIG. 4A is a view showing a robot program.

FIG. 4B is a view showing a locus of a robot moving in accordance with the robot program of FIG. 4A.

FIG. 5 is a view showing a touch operation to add a new line datum.

FIG. 6 is a view showing an edit screen of a robot program.

FIG. 7A is a view showing a touch operation to delete an unnecessary line datum.

FIG. 7B is a view showing a touch operation to delete an unnecessary line datum.

FIG. 8 is a view showing a touch operation to settle an addition of a new line datum.

FIG. 9A is a view showing an edited robot program.

FIG. 9B is a view showing a locus of a robot moving in accordance with the robot program of FIG. 9A.

### DETAILED DESCRIPTION OF THE INVENTION

Embodiments of the present invention will be described below with reference to the accompanying drawings. To facilitate understanding of the present invention, the shape and dimensions of components in the illustrated embodiments are suitably changed in some cases. Further, the same or corresponding components are designated with the same reference numerals.

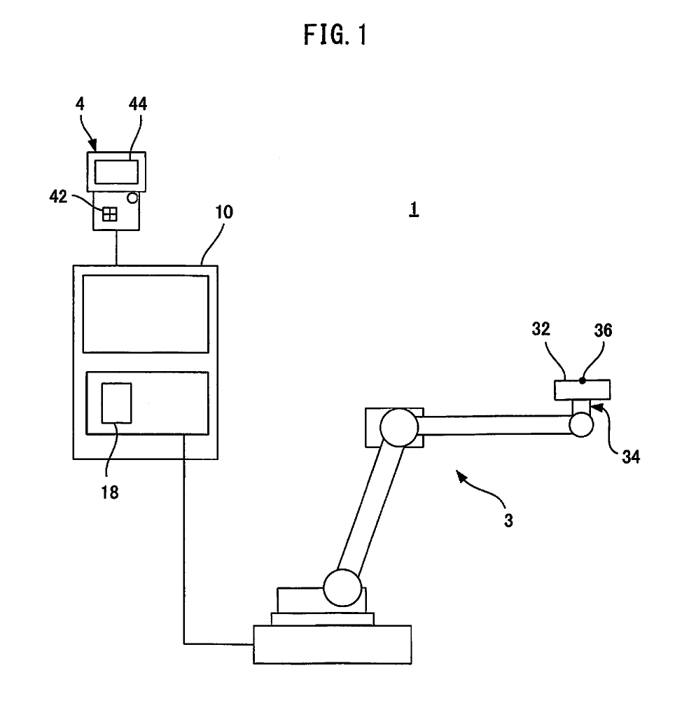

FIG. 1 is a schematic view of a robot system 1 comprising an information processing device 10 according to an embodiment. The robot system 1 has a robot 3, the information processing device 10, and a teaching operation board 4. The information processing device 10 is connected to the robot 3 and the teaching operation board 4 via a wired or wireless network. The information processing device 10 is configured to transmit/receive data and signals to/from the robot 3 and the teaching operation board 4.

The robot 3 is a multi-jointed robot having a tool 32 and a wrist 34. The robot 3 is controlled in accordance with commands produced by the information processing device 10. The robot 3 is controlled so that a predetermined working point 36 moves along a predetermined locus. Examples of the tool 32 include a holding device for holding a workpiece, a tool for machining a workpiece, etc.

The information processing device 10 produces commands for the robot 3 in accordance with a predetermined robot program. The robot program is stored in a storage device 18 provided in the information processing device 10. The storage device 18 is a non-volatile memory to store the robot program as well as setting information including parameters necessary to produce commands. In another embodiment, the robot program may be stored in an external storage device connected to the information processing device 10.

The teaching operation board 4 is a mobile terminal used for producing, editing, or displaying the robot program. The teaching operation board 4 has a switch to activate an editing function and an input device 42 used for inputting data. The input device 42 has a known configuration, such as a keyboard, button or dial.

Further, the teaching operation board 4 has a touch screen 44 for providing visual information to an operator. The touch screen 44 is configured to detect touch operations performed by a finger of an operator. The touch screen 44 is a touch screen having a known configuration. In an embodiment, the touch screen 44 may be a multi-touch screen which can detect multi-touch operations performed by simultaneously moving a plurality of fingers.

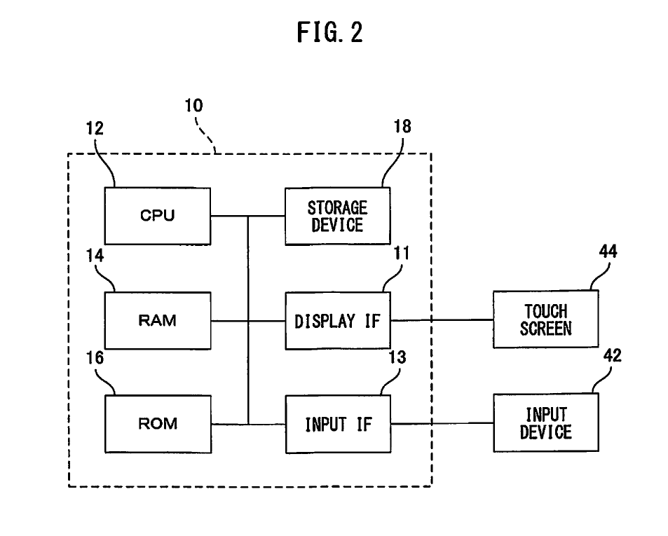

FIG. 2 is a diagram showing the hardware configuration of the information processing device 10. The information processing device 10 has a CPU 12, a RAM 14, a ROM 16, the storage device 18, a display interface (display IF) 11, and an input interface (input IF) 13, which are interconnected by bus cables.

The CPU 12 controls various functions executed by the information processing device 10. The CPU 12 executes calculations necessary to realize the functions of the information processing device 10.

The RAM 14 temporarily stores the results of the calculations in the CPU 12, or the information transmitted from an external device. The ROM 16 stores a system program for entirely controlling the operation of the information processing device 10.

As described above, the storage device 18 stores robot programs and parameters.

The display interface 11 transmits commands to the touch screen 44 of the teaching operation board 4, and transmits/receives signals to/from the touch screen 44. The input interface 13 processes data input by the input device 42 of the teaching operation board 4.

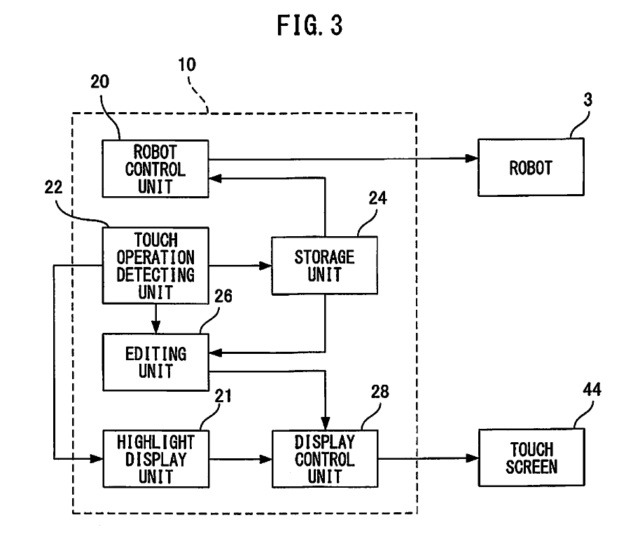

FIG. 3 is a functional block diagram of the information processing device 10. The information processing device 10 has a robot control unit 20, a touch operation detecting unit 22, a storage unit 24, an editing unit 26, a display control unit 28, and a highlight display unit 21.

The storage unit 24 reads out the information stored in the information processing device 10, or overwrites the stored information in cooperation with the RAM 14 or the storage device 28. For example, the storage unit 24 reads out a robot program from the storage device 18, or causes the storage device 18 to store a robot program edited by the teaching operation board 4.

The robot control unit 20 produces commands for the robot 3 in accordance with a predetermined robot program. The robot 3 is driven by the commands, to move the working point 36 of the tool 32 to a predetermined position.

The touch operation detecting unit 22 detects touch operations performed on the touch screen 44 of the teaching operation board 4. The touch operation detecting unit 22 distinguishably detects various touch operations, for example, single tap, double tap, triple tap, pinch-out, pinch-in, swipe, etc.

The editing unit 26 edits electronic data in response to input operations performed via the input device 42 or touch operations detected by the touch operation detecting unit 22. In an embodiment, the electronic data are electronic data in ASCII format containing a plurality of line data. The editing unit 26 has a function to add a new line datum in response to a first touch operation performed in the touch screen 44 displaying electronic data to be edited.

The highlight display unit 21 highlights a new line datum added in response to the first touch operation. The details of the function of the editing unit 26 and the highlight display unit 21 will be described later.

The display control unit 28 controls the touch screen 44 via the display interface 11, and appropriately switches the information displayed on the touch screen 44. When an operator edits electronic data, the display control unit 28 causes the touch screen 44 to display an edit display.

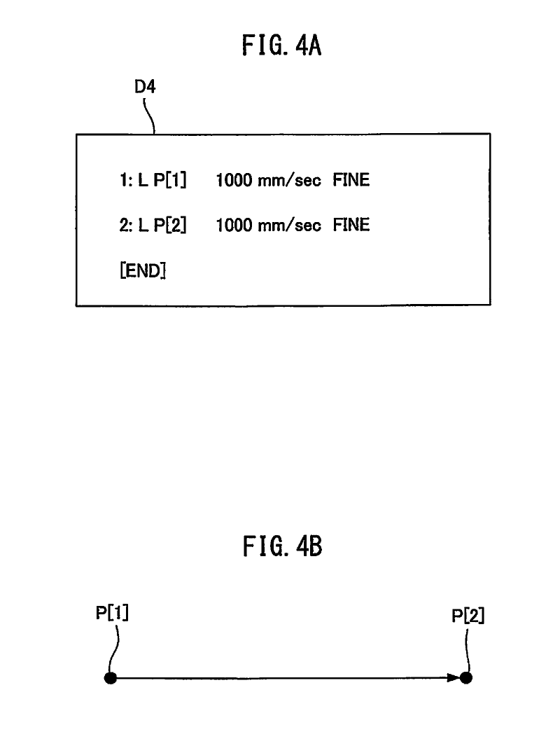

Subsequently, with reference to FIGS. 4A, 4B, and 5, the first touch operation will be described below. In an embodiment, the information processing device 10 is used to edit a robot program provided to the robot 3. In this respect, an edit display of the robot program is displayed on the touch screen 44.

With reference to FIG. 4A, a display D4 indicated on the touch screen 44 is shown. FIG. 4A shows a robot program for the robot 3. Numerals “1” and “2” designate the line numbers of line data. “L” shows that the transfer path of the working point 36 of the tool 32 is linear. “P[1]” and “P[2]” designate teaching points for the robot 3. “1000 mm/sec” designates a working speed of the robot 3. “FINE” means that the robot 3 is positioned at the designated teaching point.

FIG. 4B is a view showing a locus of the working point 36 of the robot 3 moving in accordance with the robot program of FIG. 4A. When the robot program of FIG. 4A is executed, the robot 3 is driven to position the working point 36 at a first teaching point P[1] in accordance with a command in the line datum “1”. After that, the robot 3 is driven to cause the working point 36 to linearly move toward a second teaching point P[2] and to be positioned at the second teaching point P[2] in accordance with a command in the line datum “2”.

The editing unit 26 of the information processing device 10 has a function to add a new line datum in response to the first touch operation performed in an area including a boundary between the adjacent line data “1” and “2”.

FIG. 5 shows a touch operation to add a new line datum. In an example shown in FIG. 5, a pinch-out operation is assigned as the first touch operation. The open circles in a display D5 shown in FIG. 5 designate fingers of an operator. The white arrows designate the movement of the fingers of the operator when a pinch-out operation is performed.

The pinch-out operation is performed in a predetermined area, to add a new line datum. In FIG. 5, the boundary between the line datum “1” and the line datum “2” is designated by a dotted line A, and an area B defined between lines spaced a predetermined distance from the dotted line A is designated by a dashed line.

The editing unit 26 adds a new line datum between the line datum “1” and the line datum “2” when the pinch-out operation is performed within the area B. The dotted line A and the area B are actually not displayed on the touch screen 44. Examples of the first touch operation may include single tap, double tap, etc.

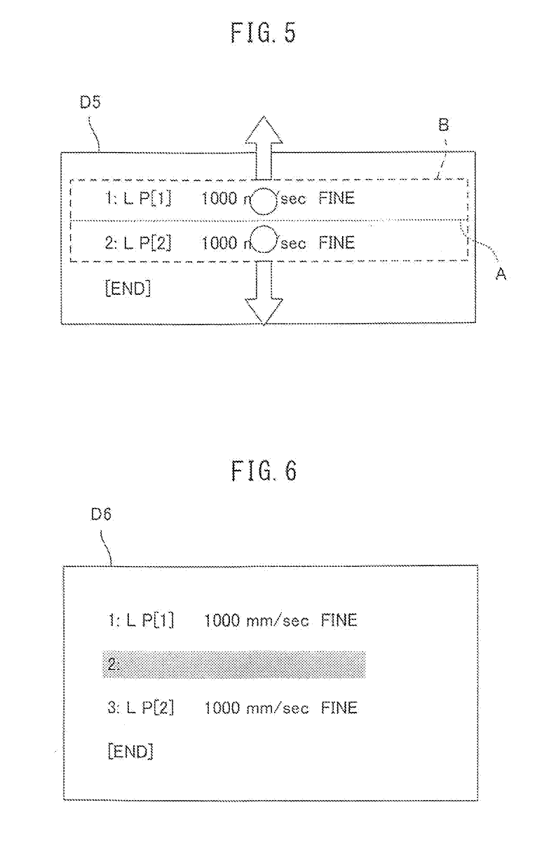

Subsequently, with reference to FIG. 6, the function of the highlight display unit 21 will be described below. FIG. 6 shows a display D6 on which a new line datum “2” added in response to the first touch operation is highlighted. Note that the line datum “2” shown in FIG. 4A have moved to a line datum “3” as a result of addition of a new line datum.

While the new line datum “2” is highlighted, the addition is not settled. Thus, if a new line datum is added by mistake, the addition can be deleted by performing a deleting operation. In an embodiment, the deleting operation is performed by a second touch operation.

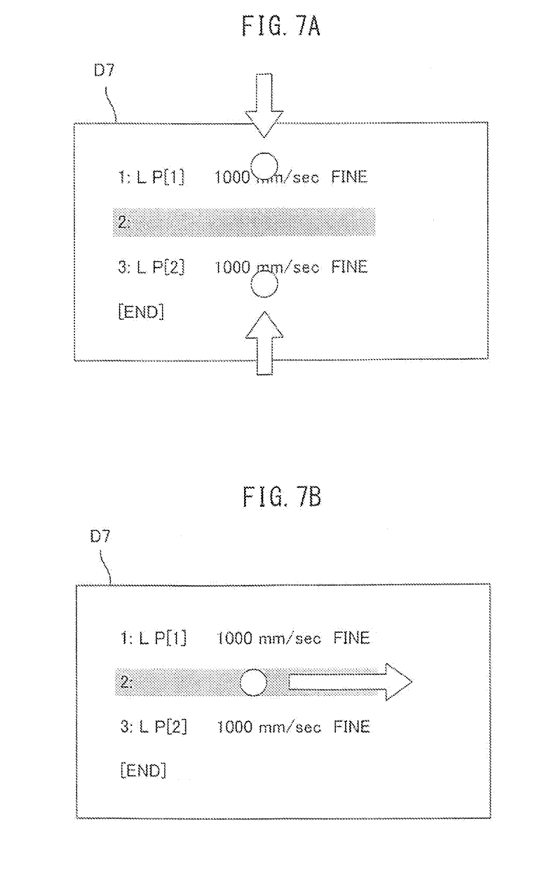

FIGS. 7A and 7B show a deleting operation which can be performed on a display D7 of the touch screen 44. FIG. 7A shows that the second touch operation is a pinch-in operation. FIG. 7B shows that the second touch operation is a swipe operation. Thus, the editing unit 26 deletes the highlighted line datum when a pinch-in or swipe operation is performed in a predetermined area including the new line datum “2”. Note that the touch operation is not limited to the aforementioned examples, and may include other touch operations.

The highlight display unit 21 changes the background color of a new line datum as shown in FIG. 6. However, other embodiments in which a new line datum is emphasized may be adopted. The highlight display unit 21 may, for example, blink the line number of a new line datum, or may change the color of characters.

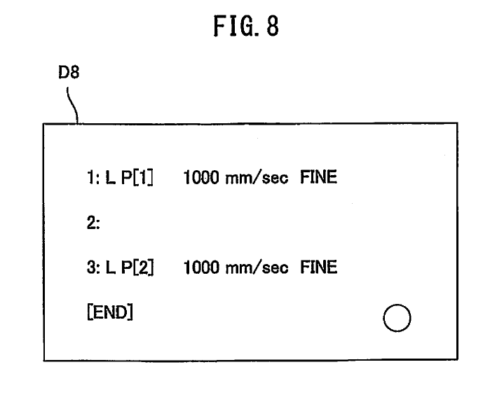

FIG. 8 shows a settling operation to settle an adding operation of the highlighted new line datum “2”. The editing unit 26 settles an adding process of the new line datum “2” when a single tap is performed at a position on a display D8 shown in FIG. 8. When the adding process is settled, the storage unit 24 of the information processing device 10 overwrites the data of the storage device 18 with the robot program to which the new line datum “2” is added. The editing unit 26 may be configured to settle an adding process by other touch operations. In another embodiment, the editing unit 26 may be configured to automatically settle an adding process when a predetermined period of time elapses without the second touch operation after the first touch operation is performed.

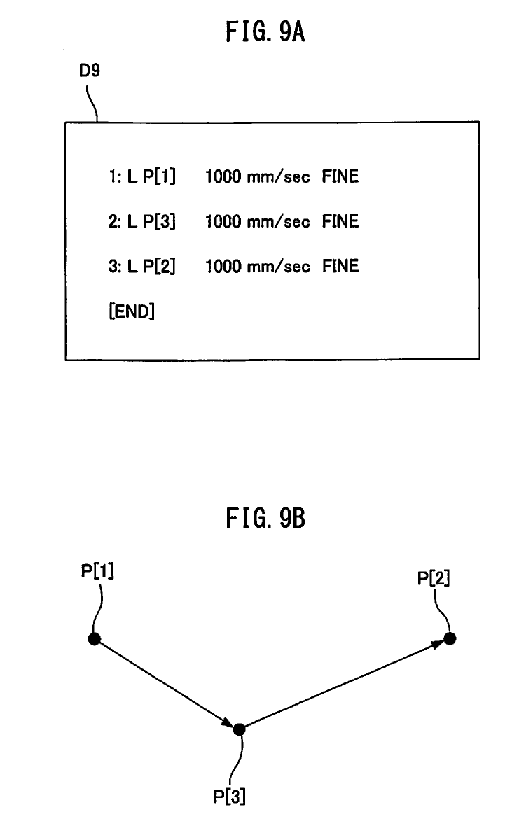

With reference to FIG. 9A, a display D9 of the touch screen 44 indicates a robot program after an additional command is input to the line datum “2”.

FIG. 9B is a view showing a locus of the working point 36 of the tool 32 moving in accordance with the robot program of FIG. 9A. The working point 36 of the tool 32 is positioned at the first teaching point P[1] by the robot 3 driven in accordance with the line datum “1” of the robot program. Subsequently, the robot 3 positions the working point 36 at a third teaching point P[3] in accordance with the line datum “2” of the robot program. Finally, the robot 3 positions the working point 36 at the second teaching point P[2] in accordance with the line datum “3” of the robot program.

According to the present embodiment, when an operator performs the first touch operation, a new line datum is added to the robot program. Further, if the operator performs the second touch operation before the adding process of the line datum is settled, the adding process of the line datum can be deleted. Thus, in comparison with command inputs or key operations which require a certain level of proficiency, the operator can intuitively edit the robot program.

In an embodiment, the editing unit 26 of the information processing device 10 may be configured to change the number of new line data to be added, in accordance with the quantity of the first touch operation. When the first touch operation is a pinch-out operation, the number of new line data to be added may be determined in accordance with the variation of the distance between two fingers of an operator before and after the operation.

When the first touch operation is a tap-and-hold gesture, the number of new line data to be added may be determined in accordance with the length of time in which the touch screen 44 is pressed by a finger of an operator.

In an embodiment, the editing unit 26 of the information processing device 10 may be configured to change the number of new line data to be deleted, in accordance with the quantity of the second touch operation. When the second touch operation is a pinch-in operation, the number of new line data to be deleted may be determined in accordance with the variation of the distance between two fingers of an operator before and after the operation.

When the second touch operation is a single tap, the number of new line data to be deleted may be determined in accordance with the number of fingers which simultaneously tap a screen.

Thus, according to the information processing device 10 configured to determine the number of line data to be added or deleted in accordance with the quantity of a touch operation, an operator can add or delete a plurality of line data by an intuitive operation.

With reference to the illustrated embodiments, the information processing device for editing a robot program has been described. However, the present invention can be applied to an information processing device for editing other electronic data, if the data are electronic data in ASCII format containing a plurality of line data. The information processing device according to the present invention may be used to edit a control program for an industrial machine, such as a processing program for a machine tool.

The information processing device according to the present invention is used to edit data in ASCII format. However, the data in ASCII format may be converted to data in another format when stored in a storage device. In this respect, when the data is read out from the storage device, the data is reconverted to data in ASCII format.

Effect of the Invention

According to the information processing device of the present invention, when electronic data are edited, a new line datum can be added in response to touch operations performed on a touch screen. An operator can intuitively add a new line datum.

Although various embodiments of the present invention have been described above, a person skilled in the art would recognize that the intended functions and effects can also be realized by other embodiments. In particular, it is possible to omit or replace a constituent element of the embodiments, or additionally provide a known means, without departing from the scope of the present invention. Further, it is obvious for a person skilled in the art that the present invention can be implemented by any combination of features of the embodiments either explicitly or implicitly disclosed herein.

1. An information processing device comprising:
a storage unit for storing electronic data in ASCII format containing a plurality of line data;
a display control unit for displaying electronic data stored in the storage unit on a touch screen; and
an editing unit for editing electronic data stored in the storage unit so that, in response to a first touch operation performed in an area containing a boundary between two adjacent line data displayed on the touch screen, a new line datum is added between the two adjacent line data.

2. The information processing device according to claim 1, wherein the editing unit is configured to change the number of new line data to be added, in response to the quantity of the first touch operation.

3. The information processing device according to claim 1, wherein the information processing device further has a highlight display unit for highlighting the new line datum; and
the editing unit is configured to edit electronic data stored in the storage unit so that the highlighted new line datum is deleted in response to a second touch operation performed on the touch screen.

4. The information processing device according to claim 3, wherein the editing unit is configured to change the number of new line data to be deleted, in response to the quantity of the second touch operation.

5. The information processing device according to claim 3, wherein the touch screen is a multi-touch screen which can detect a multi-touch operation; and
the second touch operation is a pinch-in operation.

6. The information processing device according to claim 3, wherein the second touch operation is a swipe operation.

7. The information processing device according to claim 1, wherein the touch screen is a multi-touch screen which can detect a multi-touch operation; and
the first touch operation is a pinch-out operation.
